(19) United States
(12) Patent Application Publication
(10) Pub. No.: US 2025/0165264 A1
(43) Pub. Date: May 22, 2025

(54) METHOD, APPARATUS, DEVICE AND STORAGE MEDIUM FOR INFORMATION INTERACTION

(71) Applicant: Beijing Zitiao Network Technology Co., Ltd., Beijing (CN)

(72) Inventors: Lingyu Wang, Beijing (CN); Junzhou Yang, Beijing (CN); Ou Duan, Beijing (CN); Yitian Liu, Beijing (CN); Yinqing Luo, Beijing (CN); Hong Zhang, Beijing (CN); Jun He, Beijing (CN)

(21) Appl. No.: 18/950,661

(22) Filed: Nov. 18, 2024

(30) Foreign Application Priority Data
Nov. 20, 2023 (CN) 202311553755.X

(51) Int. Cl. G06F 9/445; G06F 9/451

(52) U.S. Cl. CPC G06F 9/44526; G06F 9/453

(57) ABSTRACT

The embodiments of the disclosure provide a method, an apparatus, a device and a storage medium for information interaction. The method includes: in response to detecting that a digital assistant is triggered for an interaction event based on a first web page, providing a first link of the first web page or contents in the first web page to a web page plug-in, the web page plug-in being configured to perform a web page processing task; and performing, using the web page plug-in, interaction between a user and the digital assistant based on the contents in the first web page in an interaction window between the user and the digital assistant.

### CROSS REFERENCE

The application claims priority to Chinese Patent Application No. 202311553755X, filed on Nov. 20, 2023 and entitled “METHOD, APPARATUS, DEVICE AND STORAGE MEDIUM FOR INFORMATION INTERACTION”, the entirety of which is incorporated herein by reference.

### FIELD

Example embodiments of the disclosure generally relate to the field of computers, and in particular, to a method, an apparatus, a device, and a computer-readable storage medium for information interaction.

### BACKGROUND

With the rapid development of Internet technologies, the Internet has become an important platform for people to obtain content and share content, and users can access the Internet through terminal devices to enjoy various Internet services. A terminal device presents corresponding content through a user interface of an application and implements interaction with a user and provides service to the user. Therefore, a rich and diverse interaction interface for an application is an important means to improve user experience. With the development of information technologies, various terminal devices may provide various services to people in terms of work and life. For example, an application providing a service may be deployed in the terminal device. The terminal device or application may provide a digital assistant function to the user to assist the user in using the terminal device or application. How to improve the flexibility of interaction between a user and a digital assistant is a technical problem to be explored currently.

### SUMMARY

In a first aspect of the disclosure, a method of information interaction is provided. The method comprises: in response to detecting that a digital assistant is triggered for an interaction event based on a first web page, providing a first link of the first web page or contents in the first web page to a web page plug-in, the web page plug-in being configured to perform a web page processing task; and performing, using the web page plug-in, interaction between a user and the digital assistant based on the contents in the first web page in an interaction window between the user and the digital assistant.

In a second aspect of the disclosure, an apparatus for information interaction is provided. The apparatus comprises: a web page providing module configured to in response to detecting that a digital assistant is triggered for an interaction event based on a first web page, provide a first link of the first web page or contents in the first web page to a web page plug-in, the web page plug-in being configured to perform a web page processing task; and an interaction performing module configured to perform, using the web page plug-in, interaction between a user and the digital assistant based on contents in the first web page in an interaction window between the user and the digital assistant.

In a third aspect of the disclosure, an electronic device is provided. The device comprises: at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the disclosure, a computer-readable storage medium is provided. The computer-readable storage medium stores a computer program, and the computer program is executable by the processor to implement the method of the first aspect.

It should be understood that the content described in this section is not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the disclosure can be implemented;

FIG. 2A to FIG. 2C illustrate schematic diagrams of an example interface of an interaction window according to some embodiments of the disclosure;

FIG. 3 illustrates a schematic diagram of a flow of information interaction according to some embodiments of the disclosure;

FIG. 4 illustrates a flowchart of a feed of information interaction according to some embodiments of the disclosure;

FIGS. 5A to FIG. 5E illustrate schematic diagrams of an example client interface of an interactive window according to some embodiments of the disclosure;

FIG. 6 illustrates a schematic diagram of a feed of information interaction according to some other embodiments of the disclosure;

FIG. 7 illustrates a flowchart of a feed of information interaction flow according to some other embodiments of the disclosure;

FIG. 8 illustrates a schematic diagram of an example client interface of an interaction window according to some other embodiments of the disclosure;

FIG. 9 illustrates a flowchart of a feed of a web page jump according to some embodiments of the disclosure;

FIG. 10 illustrates an example of an architecture of information interaction according to some embodiments of the disclosure;

FIG. 11 illustrates an example of information interaction according to some embodiments of the disclosure;

FIG. 12 illustrates a schematic diagram of a framework for determining a recommendation instruction according to some embodiments of the disclosure;

FIG. 13 illustrates a flowchart of a process for information interaction according to some embodiments of the disclosure;

FIG. 14 illustrates a block diagram of an apparatus for information interaction according to some embodiments of the disclosure; and

FIG. 15 illustrates a block diagram of an electronic device capable of implementing one or more embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments of the disclosure are for exemplary purposes only and are not intended to limit the scope of the disclosure.

In the description of the embodiments of the disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performing one step does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related rules.

It can be understood that before using the technical solutions disclosed in the embodiments of the disclosure, related users should be informed of the types, use ranges, usage scenes, and the like of the information related to the disclosure in an appropriate manner according to relevant laws and regulations, and the authorization of the related users may be obtained, wherein the related users may include any type of rights body, such as individuals, businesses, and groups.

For example, in response to receiving an active request from a user, prompt information is sent to the related user to explicitly prompt the related user that the requested operations to be performed would require acquisition and use of information of the related user, such that the related user can autonomously select whether to provide information to software or hardware such as an electronic device, an application, a server, or a storage medium that performs the operations of the technical solution of the disclosure, according to the prompt information.

As an optional but non-limiting implementation, in response to receiving an active request from a related user, a manner of sending prompt information to the related user may be, for example, a pop-up window, and the pop-up window may present the prompt information in a text manner. In addition, the pop-up window may further carry a selection control for the user to select “agree” or “disagree” to provide information to the electronic device.

It may be understood that the foregoing process of notifying and acquiring user authorization is merely illustrative, and does not constitute a limitation on the implementations of the disclosure, and other manners that meet related laws and regulations may also be applied to the implementations of the disclosure.

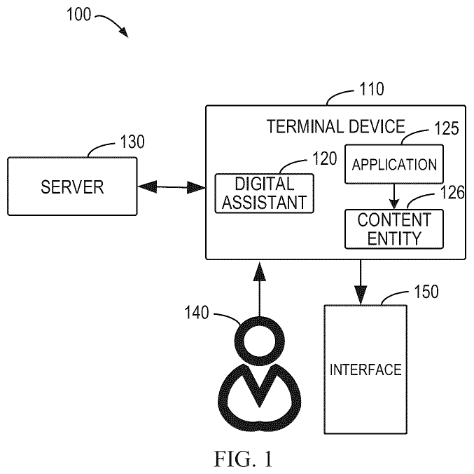

FIG. 1 illustrates a schematic diagram of an example environment 100 in which embodiments of the disclosure can be implemented. In this example environment 100, a digital assistant 120 and an application 125 are installed in the terminal device 110. A user 140 may interact with the digital assistant 120 and the application 125 via the terminal device 110 and/or an attachment device of the terminal device 110.

In some embodiments, the digital assistant 120 and the application 125 may be downloaded, installed on the terminal device 110. In some embodiments, the digital assistant 120 and the application 125 may also be accessed in other manners, for example, accessed through a web page. In the environment 100 of FIG. 1, in response to the application 125 being launched, the terminal device 110 may present an interface 150 of the digital assistant 120 and the application 125.

The applications 125 includes, but are not limited to, one or more of: chat applications (also known as instant messaging applications), document applications, audio and video conference applications, mail applications, task applications, calendar applications, objectives and key results (OKR) applications, and so forth. Although a single application is shown in FIG. 1, in practice, a plurality of applications may be installed on the terminal device 110. In some embodiments, the application 125 may include a multifunction collaboration platform, such as an office collaboration platform (also referred to as an office suite), which can provide integration of multiple types of applications or components, so that people can conveniently conduct activities such as office work and communication. In a multifunctional collaboration platform, people can start different applications or components according to the needs to complete corresponding information processing, sharing, communication and the like.

The application 125 may provide a content entity 126. The content entity 126 may be a content instance created by the user 140 or other users on the application 125. For example, depending on the type of the application 125, the content entity 126 may be a document (e.g., a word document, a pdf document, a presentation, a table document, etc.), a mail, a message (e.g., a conversation message on an instant messaging application), a calendar, a schedule, a task, an audio, a video, an image, or the like.

In some embodiments, the digital assistant 120 may be provided by a separate application, or integrated into certain application 120 capable of providing the content entity. The application of the client interface for providing the digital assistant may correspond to a single functional application or a multifunction collaboration platform, such as an office suite or other collaboration platform capable of integrating a plurality of components. In some embodiments, the digital assistant 120 supports the use of plug-ins. Each plug-in may provide one or more functions of the application. Such plug-ins include, but are not limited to, one or more of: a search plug-in, a contact plug-in, a message plug-in, a document plug-in, a table plug-in, a mail plug-in, a calendar plug-in, a schedule plug-in, a task plug-in, and the like.

The digital assistant 120 is a user intelligent assistant and has an intelligent dialogue and information processing capability. In an embodiment of the disclosure, the digital assistant 120 is configured to interact with the user 140 to assist the user 140 in using the terminal device or the application. An interaction window with the digital assistant 120 may be presented in the client interface. In the interaction window, the user 140 may interact with the digital assistant 120 by inputting natural language to indicate the digital assistant to assist in completing various tasks, including the operations of the content entity 126.

In some embodiments, the digital assistant 120 may be included as a contact of the user 140 in a contact list of the current user 140 in the office suite, or in the feed of the chat component. In some embodiments, the user 140 has a corresponding relation with the digital assistant 120. For example, the first digital assistant corresponds to the first user, the second digital assistant corresponds to the second user, and so on. In some embodiments, the first digital assistant may uniquely correspond to the first user, the second digital assistant may uniquely correspond to the second user, and so on. That is, the first digital assistant of the first user may be specific or dedicated to the first user. For example, in a process in which the first digital assistant provides assistance or service to the first user, the first digital assistant may utilize its historical interaction information with the first user, data authorized by the first user that can be accessed by the first digital assistant, current interaction context of the first digital assistant and the first user, and the like. If the first user is an individual or a person, the first digital assistant may be considered a personal digital assistant. It may be understood that, in the disclosed embodiment, the first digital assistant accesses the data granted rights based on the authorization of the first user. It should be understood that the “uniquely correspond” or the like in the disclosure is not intended to limit that the first digital assistant will be updated accordingly based on the interaction process between the first user and the first digital assistant. Of course, the digital assistant 120 is not necessarily specific to the current user 140, but may be a universal digital assistant, depending on the needs of the actual application.

In some embodiments, a plurality of interaction modes between the user 140 and the digital assistant 120 may be provided, and be flexibly switched between the plurality of interaction modes. In the case that a certain interaction mode is triggered, a corresponding interaction region is presented to facilitate interaction between the user 140 and the digital assistant 120. The interaction manners between the user 140 and the digital assistant 120 in different interaction modes are different, which can flexibly be adapted to interaction requirements in different application scenes.

In some embodiments, the information handling service specific to the user 140 can be provided based on historical interaction information between the user 140 and the digital assistant 120 and/or a data range specific to the user 140. In some embodiments, the historical interaction information that the user 140 interacts with the digital assistant 120 in the plurality of interaction modes respectively may be stored in association with the user 140. As such, in one of the plurality of interaction modes (any or a designated interaction mode), the digital assistant 120 may provide services to the user 140 based on the historical interaction information stored in association with the user 140.

The digital assistant 120 may be called or activated in an appropriate manner (e.g., via a shortcut, a button, or a voice) to present an interaction window with the user 140. By selecting the digital assistant 120, an interaction window with the digital assistant 120 may be opened. The interaction window may include an interface element for information interaction, such as an input box, a message list, a message bubble, and the like. In some other embodiments, the digital assistant 120 may be invoked through an entry control or a menu provided in the page, or be invoked by inputting a predetermined instruction.

In some embodiments, the interaction window between the digital assistant 120 and the user 140 may include a conversation window, such as a conversation window in an instant messaging application or an instant messaging module of the target application. In some embodiments, the interaction window between the digital assistant 120 and the user 140 may include a floating window corresponding to the digital assistant. In some embodiments described below, for ease of discussion, the interaction window between the user and the digital assistant being is a conversation window is mainly used as an example for description.

In some embodiments, the digital assistant 120 may support an interaction mode of a conversation window, also referred to as a conversation mode. In this interaction mode, a conversation window between the user 140 and the digital assistant 120 is presented, and the user 140 interacts with the digital assistant 120 through the conversation message in the conversation window. In the conversation mode, the digital assistant 120 may perform a task according to the conversation message in the conversation window.

In some embodiments, the conversation mode between the user 140 and the digital assistant 120 may be called or activated in an appropriate manner (e.g., a shortcut, a button, or a voice) to present the conversation window. By selecting the digital assistant 120, a conversation window with the digital assistant 120 may be opened. The conversation window may include interface elements for information interaction, such as input boxes, message lists, message bubbles, and the like.

In some embodiments, the digital assistant 120 may support a floating window (or floating window) interaction mode, also referred to as a floating window mode. In the case that the floating window mode is triggered, an operation panel (also referred to as a floating window) corresponding to the digital assistant 120 is presented, and the user 140 may issue an instruction to the digital assistant 120 based on the operation panel. In some embodiments, the operation panel may include at least one candidate shortcut instruction. Alternatively, or additionally, the operation panel may include an input control for receiving instructions. In the floating window mode, the digital assistant 120 may perform a task according to an instruction issued by the user 140 through the operation panel.

In some embodiments, the floating window mode between the user 140 and the digital assistant 120 may also be called or activated in an appropriate manner (for example, a shortcut key, a button, or a voice) to present a corresponding operation panel. In some embodiments, the activation of the digital assistant 120 may be supported in a particular application, such as in a document application, to provide a floating window mode of interaction. In some embodiments, to trigger the floating window mode to present the operation panel corresponding to the digital assistant 120, an entry control for the digital assistant 120 may be presented in the application interface. In response to detecting the trigger operation for the entry control, it may be determined that the floating window mode is triggered and the operation panel corresponding to the digital assistant 120 is presented in the target interface region.

In some embodiments described below, for ease of discussion, the interaction window between the user and the digital assistant being is a conversation window is mainly used as an example for description.

In some embodiments, the terminal device 110 communicates with the server 130 to enable provisioning of services to the digital assistant 120 and the application 125. The terminal device 110 may be any type of mobile terminals, fixed terminals, or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The server 130 may be various types of computing systems/servers that can provide computing capabilities, including, but not limited to, mainframes, edge computing nodes, computing devices in a cloud environment, and the like.

It should be understood that the structures and functions of the various elements in the environment 100 are described for exemplary purposes only and do not imply any limitation to the scope of the disclosure.

As briefly mentioned above, a digital assistant may assist a user in using a terminal device or an application. Some applications can provide integrated functionality for different plug-ins. In addition to the free dialogue with the digital assistant, the user can make the digital assistant complete some more complex operations related to the business of the application by using different plug-ins through the natural language instruction, such as creating a document, inviting a schedule, creating a task, and the like.

According to some embodiments of the disclosure, an improved solution for information interaction is provided. In an embodiment of the disclosure, in response to detecting that a digital assistant is triggered for an interaction event based on a first web page, providing a first link of the first web page or contents in the first web page to a web page plug-in. The web page plug-in here is associated with a digital assistant, such as an interaction selected for a digital assistant. The web page plug-in is configured to perform web page processing tasks. In this way, performing, using the web page plug-in, interaction between a user and the digital assistant based on the contents in the first web page in an interaction window between the user and the digital assistant.

In general, though a user may send a conversation message containing a link to the digital assistant to have the digital assistant interact with the user based on the data corresponding to the link, such a link is typically document-only type of link that an application integrating a digital assistant can provide. According to embodiments of the disclosure, by providing the web page plug-in, the digital assistant may obtain the contents in a third-party web page, which not only expanded the application scenarios of the digital assistant, but also helps to reduce the difficulty and complexity of interaction between the user and the digital assistant, and improve the efficiency of interaction.

Some example embodiments of the disclosure will be described in detail below with reference to examples of the accompanying drawings.

### Example Interaction Window

As described above, in an embodiment of the disclosure, the digital assistant is configured to interact with a user. An interactive window between the user and the digital assistant may be presented in a client interface. The interaction window between the user and the digital assistant may include a conversation window, and the interaction between the user and the digital assistant in the conversation window may be presented in a form of a conversation message. Alternatively, or additionally, the interaction window between the user and the digital assistant may further include other types of windows, such as a window of a floating window mode, where the user may trigger the digital assistant to perform corresponding operations by inputting an instruction, selecting a shortcut instruction, or the like. The digital assistant serves as an intelligent assistant and has an intelligent dialogue and information processing capability. In the interaction window, the user inputs an interaction message, and the digital assistant provides a reply message in response to the user input. A client interface for providing the digital assistant may correspond to a single functional application or a multifunction collaboration platform, such as an office suite or other collaboration platform capable of integrating a plurality of components.

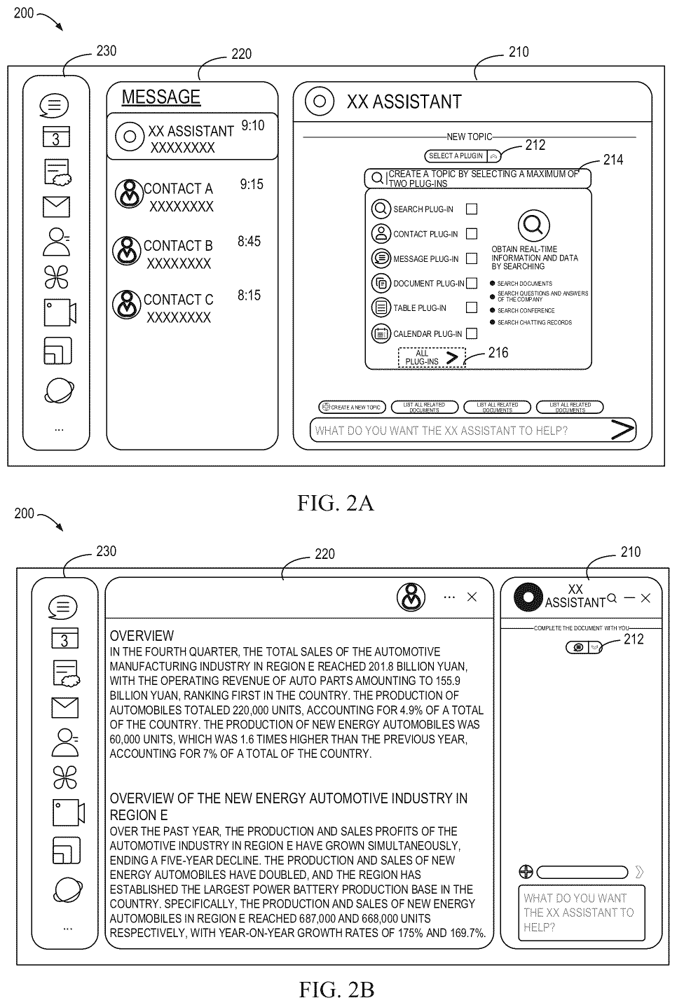

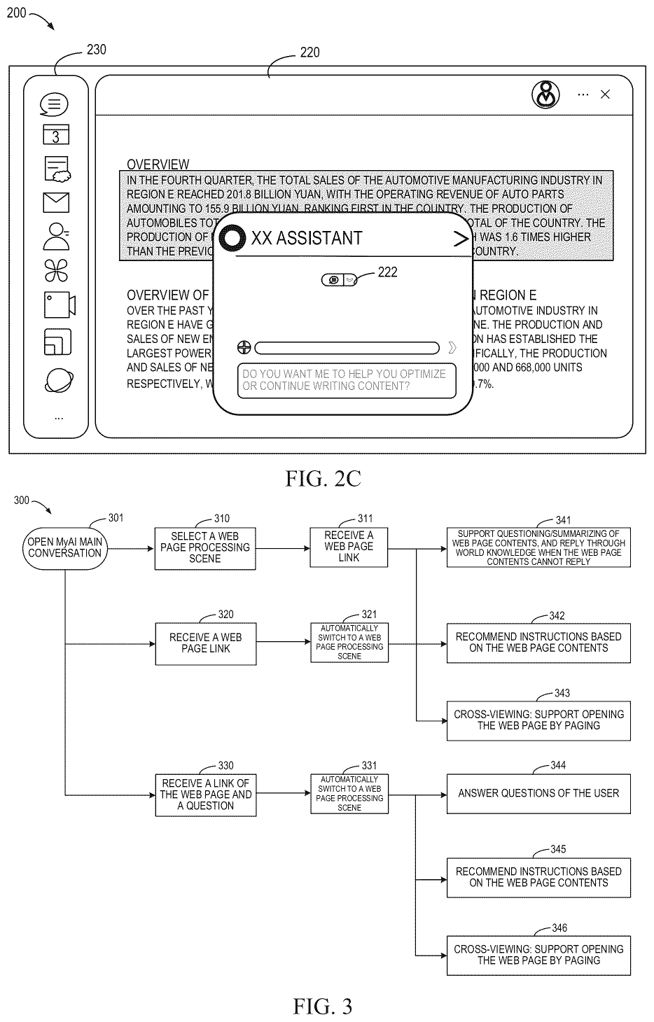

FIGS. 2A-2C illustrate schematic diagrams of an example client interface 200 of an interactive window according to some embodiments of the disclosure. The client interface 200 may be implemented at the terminal device 110. Examples of FIGS. 2A-2C are described below with reference to FIG. 1.

In some embodiments, in response to the user (also referred to as a first user) invoking the digital assistant through a predetermined operation (for example, selecting a digital assistant from a contact list), the terminal device 110 may present a conversation window (also referred to as a main conversation window) and a plug-in selection control that interact with the digital assistant by the first user. With such a plug-in selection control, the first user may select a plug-in to be used in a main conversation window.

In some embodiments, as shown in FIG. 2A, the main conversation window between the digital assistant (shown as “XX assistant” in the figure) and the user is presented in the region 210 of the interface 200. The digital assistant may be considered as one of the contacts of the user, presented in information stream (“feed”) of an instant messaging application. The instant messaging application is presented in the region 230 of the interface 200, and the feed is presented in the region 220 of the interface 200. The user selects the digital assistant in the instant messaging application to enter the main conversation window. The main conversation window includes a plug-in selection control 212. The user may select a plug-in to be used in the conversation window by clicking on the plug-in the selection control 212.

In some embodiments, the terminal device 110 invokes a digital assistant in a page (for example, a page browsing a document) in response to the user performing a predetermined operation (for example, triggering a predetermined control, inputting a predetermined instruction or a voice activation, and the like), and presents a sub-conversation window that the user interacts with the digital assistant. Such a sub-conversation window includes a plug-in selection control. With such a plug-in selection control, the user may select and use the plug-in in the sub-conversation window.

In some embodiments, in response to detecting a selection operation (e.g., a click operation) on the plug-in selection control 212, the terminal device 110 may present a plug-in selection panel 214. The plug-in selection panel 214 is presented with pre-stored, at least one plug-in that has been created (e.g., a search plug-in, a contact plug-in, a message plug-in, etc. shown in FIG. 2A). In some embodiments, a plug-in viewing control 216 is also presented in the plug-in selection panel 214. For example, the terminal device 110 may present, in response to detecting a selection operation on the plug-in viewing control 216, all plug-ins included in the terminal device 110.

In some embodiments, the terminal device 110 invokes a digital assistant in a first page (for example, a page browsing a document) in response to the user performing a predetermined operation (for example, triggering a predetermined control, inputting a predetermined instruction or a voice activation), and displays a sub-conversation window (also referred to as an interaction window) that the first user interacts with the digital assistant. Such a sub-conversation window includes a plug-in selection control. With such a plug-in selection control, the user may select and use the plug-in in the sub-conversation window.

In some embodiments, the interaction window is presented in association with the target content. For example, as shown in FIG. 2B, the user selects a document application in the region 230 and views the target content in the document in the region 220. During the viewing process, the user invokes the digital assistant, for example, by triggering a predetermined control or menu in the region 220, or also invoke the digital assistant through the voice. Terminal device 110, in response to such an operation, presents a sub-conversation window between the user and the digital assistant in the region 210 of the interface 200. It should be noted that, in FIG. 2B and other drawings, the region 210 including the sub-conversation window and the region 220 including the target content are used as an example for description. In other embodiments, they may be arranged in other manners as required. For example, the region 210 may be presented on the left and the region 220 may be presented on the right in the client interface. For another example, the region 210 and the region 220 may also be arranged in an up-and-down partition manner, and the like. The sub-conversation window includes a plug-in selection control 212. The user may select a plug-in to be used in the conversation window by clicking on the plug-in selection control 212.

In some embodiments, the application where the main conversation window is located and the application in which the sub-conversation window is located are different applications. For example, the application where the main conversation window is located may be an instant messaging application for the user to communicate with other users and the digital assistant. For example, an application capable of invoking the sub-conversation window may be other application other than an instant messaging application, such as a document application, a table application, a calendar application, a schedule application, a conference application, a project management application, a customer relationship management CRM application, or the like.

In some embodiments, the terminal device 110 may trigger the digital assistant and present the interaction window in a region in which the target content of the first page is displayed. Specifically, as shown in FIG. 2C, after the part of content of the target document in the selected region 220 is selected, a menu (not shown) may be displayed by a click of the right-key, where the menu (not shown) includes an entry control of the digital assistant. By triggering the entry control, an interaction window as shown in FIG. 2C may be presented. In this example, the interaction window is presented in a floating window style, also referred to as a floating window interaction window or a floating window conversation window. Of course, in addition to the right-click manner, the floating window interaction window may be triggered in various other appropriate manners, which is not limited in the embodiments of the disclosure. The plug-in selection control 222 may also be presented in the floating window interaction window. The user may select a plug-in to be used in the conversation window by clicking on the plug-in selection control 222.

In some embodiments, the terminal device 110 displays an interaction window (also referred to as an interaction window) between the user and the digital assistant in response to an operation of invoking the digital assistant in the first page. Such interaction windows may include a sub-conversation window and a floating window interaction window. The trigger operations of the presenting the sub-conversation window and the floating window interaction window may be the same or different. For example, in the process of browsing the document content by using the document application, the user invokes the digital assistant through the voice, and then the terminal device 110 presents the sub-conversation window in a side region of the region where the document content is displayed. For another example, in the process of browsing the document content by using the document application, the user invokes the digital assistant by selecting a certain segment of text, and the terminal device 110 presents the floating window interaction window in the region where the document content is displayed.

In some embodiments, the terminal device 110 may synchronize the interaction message in the interaction window to the main conversation window in which the user interacts with the digital assistant. For example, when the user switches to use the instant messaging application, the terminal device 110 may synchronize the conversation message between the user and the sub-conversation window in document application to the main conversation window. In this way, both the user and the digital assistant may be made aware of the context information.

It should be understood that the document is taken as an example of the target content for description in the drawings. In other embodiments, the target content may also include any other appropriate content that the platform may process, including but not limited to an audio, a video, an image, a mail, a calendar, a schedule, a task, and the like. For these contents, a digital assistant may be invoked and a conversation window presented.

FIGS. 2A-2C illustrate a plurality of examples of enabling a conversation window of the user and the digital assistant. It should be understood that the conversation window may also be enabled in other manners. In addition, various specific information, icons and the like given in FIGS. 2A-2C are merely examples, and not intended to limit the scope of the embodiments of the disclosure.

### Example Embodiments of Interaction Based on Web Page

In some embodiments, in an interaction window (for example, a main conversation window, a sub-conversation window, a floating window interaction window, and the like) between the user and the digital assistant, the terminal device 110 receives a message (which may be referred to as a first message) from the user. The first message may include a first link of a first web page. The first message may further include other contents, for example, the first message may further include a question of the user for the first web page. The first web page may be any appropriate web page, and the disclosure does not limit the first web page and/or the first link. In response to receiving the first message containing the web page link, the terminal device 110 will detect that the digital assistant is triggered for the interaction event based on the first web page.

In an embodiment of the disclosure, in a case that it is determined that the digital assistant is triggered for interaction based on the first web page, the terminal device 110 obtains the contents in the first web page from the first link using the web page plug-in, and performs interaction between the user and the digital assistant based on the contents in the first web page at least using the web page plug-in. The web page plug-in herein is a plug-in configured to perform a web page processing task. For example, the web page plug-in may perform a content extraction task, a content summary task, a content comparison task, and the like for the web page, and the disclosure does not limit the web page processing task specifically performed by the web page plug-in. In some embodiments, the web page plug-in may call the model to complete the web page processing task. The model may be a machine learning model, a deep learning model, a learning model, a neural network, or the like. In some embodiments, the model may be based on a language model (LM). The language model can have question-answering capability by learning from a large corpus of corpora. The model may also be based on other suitable models. In some embodiments, the web page plug-in may further call an open interface provided by another application (for example, an application such as a calendar and a conference) to complete the web page processing task.

Various example embodiments of the disclosure will be described in detail below with continued reference to the accompanying drawings. In order to more clearly understand the information interaction solution of the disclosure, a plurality of examples of performing information interaction in the interaction window are first described with reference to FIG. 3 to FIG. 5E. For ease of description, the interaction window is taken as a main conversation window in FIG. 3 to FIG. 5E for example description. It will be appreciated that the information interaction performed in the main conversation window may be similarly implemented on the sub-conversation window and the floating window interaction window.

FIG. 3 illustrates a schematic diagram of a flow 300 of information interaction according to some embodiments of the disclosure. As shown in FIG. 3, at block 301, the terminal device 110 may present a main conversation window between the user and the digital assistant. In some embodiments, if there previously is historical interaction information or a historical topic between the user and the digital assistant, in response to the digital assistant being invoked, the terminal device 110 may present the historical interaction information or a part of the historical topic in the main conversation window. Herein, a “topic” corresponds to a particular context of an interaction. During the interaction process of each topic, the interaction information between the user and the digital assistant may be considered as context information, to assist the digital assistant in determining a subsequent conversation message. In some embodiments, topics are also sometimes referred to as or presented as topics. Alternatively, or additionally, in some embodiments, in response to the digital assistant being invoked, the terminal device 110 may not present historical interaction information or a part of the historical topic in the main conversation window. In this case, the terminal device 110 may present, for example, the interaction guidance information in the main conversation window in response to the digital assistant being invoked. The interaction guidance information may be used, for example, to guide a user to open a new topic, select a scene, select a plug-in, and the like. For example, the terminal device 110 may present the interaction guidance information in the main conversation window by presenting a guidance message card. It may be understood that the terminal device 110 may present the interaction guidance information in any appropriate manner (for example, a pop-up window), which is not limited in the disclosure.

For example, the terminal device 110 may present at least one scene in the guide message card. The scene herein refers to a set of tasks of a same type, that is, one scene corresponds to a plurality tasks of a same type. One or more scenes may be configured with corresponding configuration information to perform corresponding types of tasks, respectively. In some embodiments, the terminal device 110 may perform, in response to receiving the selection of the first scene in the at least one scene in the guidance message card, interaction between the user the digital assistant based at least on the configuration information of the first scene in the new topic. The configuration information of the scene includes at least one of the following: scene setting information or plug-in information. The scene setting information of the scene may affect the reply of the digital assistant to the user to a certain extent, or may be used to determine the reply of the digital assistant to the user. The plug-in information indicates at least one plug-in for performing a task in a corresponding scene. Through the plug-in information of the scene, the plug-in to be used in the corresponding scene may be configured.

In some embodiments, the terminal device 110 may further present an operation control for selecting a scene in the main conversation window. For example, the terminal device 110 may provide a set of scenes, for example, in response to detecting a trigger operation (e.g., a click operation, a long-press operation, a double-click operation, a slide operation, a hover operation, etc.) on the operation control for selecting the scene. The set of scenarios may include at least one scenario. The terminal device 110 in turn starts, in response to receiving the selection of the first scene in the set of scenes, the first topic in the conversation window, and in the first topic, performs interaction between the user and the digital assistant based on at least the configuration information of the first scene.

At block 310, if the user expects the digital assistant to perform the web page processing task, the selected first scene may be a scene related to web page processing. The scene related to web page processing herein may be any appropriate scene, for example, a web page question-answer scene, a web page content summary scene, and the like. For ease of description, the scene related to web page processing may be collectively referred to as a web page processing scene. In this case, at block 311, the terminal device 110 may receive, in the main conversation window, a first message including the first link of the first web page. The first link of the first web page may also be referred to simply as a first web page link. That is, the terminal device 110 may receive the first message including the first web page link. Further, the terminal device 110 may obtain contents in the first web page from the first link using the web page plug-in, and perform interaction between the user and the digital assistant based on the contents in the first web page at least using the web page plug-in. In some embodiments, the terminal device 110 may perform interaction between the user and the digital assistant based on the configuration information of the web page processing scene and the contents in the first web page. For example, the terminal device 110 may perform the interaction shown in blocks 341,342, and 343.

In some embodiments, if the first scene selected by the user is not a web page processing scenario or the first scene is not selected by the user, the terminal device 110 may perform interaction between the user and the digital assistant based on the first scene, or may not perform interaction between the user and the digital assistant based on the scene. In this case, the terminal device 110 may still receive the first message including the first link of the first web page in the main conversation window. Taking the first message only including the first link as an example, at block 320, the terminal device 110 may receive the first link of the first web page. At block 321, the terminal device 110 may automatically switch to a web page processing scene matching the first message based on the first message. Similarly, the terminal device 110 may obtain the contents in the first web page from the first link using the web page plug-in, and perform the interaction between the user and the digital assistant based on the contents in the first web page at least using the web page plug-in. For example, the terminal device 110 may perform the interaction shown in block 341, block 342, and block 343.

At block 341, the terminal device 110 supports the user to question for the web page contents/summarize the web page, and may reply with the world knowledge when the web page contents cannot reply. The world knowledge herein refers to any appropriate knowledge that may be obtained by the digital assistant in a rule-compliant manner. For example, the terminal device 110 may present the scene guidance information in the main conversation window. The scene guidance information may be used to prompt the user web page processing scene to support a user to question for the web page contents/summarize the web page.

At block 342, the terminal device 110 may further determine a set of recommendation instructions based on the contents of the first web page. For example, the terminal device 110 may present the determined set of recommendation instructions in the main conversation window. The terminal device 110 may present the first recommendation instruction in the main conversation window in response to detecting a selection operation on the first recommendation instruction in the set of recommendation instructions. For example, the terminal device 110 may present the first recommendation instruction in the main conversation window in a form of a conversation message from the user. The terminal device 110 may perform the web page processing task indicated by the first recommendation instruction based on the first recommendation instruction.

At block 343, the terminal device 110 may further support the operation of opening the web page by paging. The web page here may be a first web page or any other appropriate web page. Taking the first web page as an example, the terminal device 110 may present the first web page in response to detecting a trigger operation on the first link of the first web page. For example, the terminal device 110 may present the first web page while presenting the main conversation window. The location relationship between the first web page and the main conversation window may be any appropriate location relationship. For example, the first web page may be located on the right side of the main conversation window, the first web page may be located on the left side of the main conversation window, and the like, which is not limited in the disclosure. In this way, the operation of switching from presenting the main conversation window to presenting the main conversation window and the first web page may also be referred to as a paging operation. This facilitates the user to view the contents of the first web page while interacting with the digital assistant, which may also be referred to as cross-viewing. That is, the terminal device 110 supports performing the cross-viewing service on the first web page.

In some embodiments, in the case that the first scene selected by the user is not a web page processing scene or the first scene is not selected by the user, the first message including the first link of the first web page received by the terminal device 110 in the main conversation window may further include a question of the user for the first web page. In this case, at block 330, the terminal device 110 may receive the first link of the first web page and the question of the user indicated by the question. At block 331, the terminal device 110 may automatically switch to a web page processing scene matching the first message based on the first message. Similarly, the terminal device 110 may obtain the contents in the first web page from the first link using the web page plug-in, and perform the interaction between the user and the digital assistant based on the contents in the first web page at least using the web page plug-in. For example, the terminal device 110 may perform the interaction shown in blocks 344,345, and 346.

At block 344, the terminal device 110 may answer the question of the user indicated by the question in the first message based on the contents of the first web page. In the web page processing scene, the terminal device 110 may determine, for example, a reply message for the first message based on the contents of the first web page and the question of the user. In a case that the reply message cannot be determined only based on the contents of the first web page, for example, the terminal device 110 may also determine a reply to the user based on the world knowledge. It may be understood that the reply message may be determined by a digital assistant in the terminal device 110 and presented by the terminal device 110 in the main conversation window. The interaction shown in block 345 and block 346 is the same as the interaction shown in block 342 and block 343, and details are not described herein again.

It should be noted that, in some embodiments, before extracting the web page contents and performing the interaction using the web page plug-in, the terminal device 110 further needs to determine whether the web page plug-in is enabled. It may be understood that, in a case that the web page plug-in is enabled, the terminal device 110 may extract the web page contents and perform the interaction using the web page plug-in. In some embodiments, the terminal device 110 may determine that the web page plug-in is enabled based on the first message including the first link. That is, in response to receiving a conversation message including the link of the web page, the web page plug-in may be enabled by default.

Alternatively, or additionally, in some embodiments, the terminal device 110 further needs to further determine a current scene of performing the interaction, and the terminal device may determine that the web page plug-in is enabled in response to receiving the first message when the scene related to the web page processing is selected for interaction. The terminal device 110 may also determine that the web page plug-in is enabled in response to receiving the first message in a scenario where a scene related to web page processing is selected for interaction. That is, in the web page processing scene, the terminal device 110 may default the web page plug-in to be enabled. In a non-web page processing scene (for example, other scenes other than a web page processing scene, or no scene), the terminal device 110 may switch to the web page processing scene and enable the web page plug-in in response to receiving the first message including the first link of the first web page.

In some embodiments, because different web pages may include different types of contents, the links may also be different types of links. In some embodiments, to ensure correctness of the called plug-in, the terminal device 110 may further determine whether the web page plug-in is configured to process the link type corresponding to the first link. The terminal device 110 may further determine that the web page plug-in is enabled based on determining that the web page plug-in is configured to process the link type corresponding to the first link. For example, the terminal device 110 may determine, based on the related information of the web page plug-in, whether the web page plug-in is configured to process a link type corresponding to the first link. For example, the terminal device 110 may further provide the first link to the web page plug-in, and the web page plug-in determines whether the web page plug-in is a link the link type that can be processed by itself. For example, if the first web page is a web page of a document type, the terminal device 110 may determine that the first link of the first web page is not a link of a link type that may be processed by the web page plug-in.

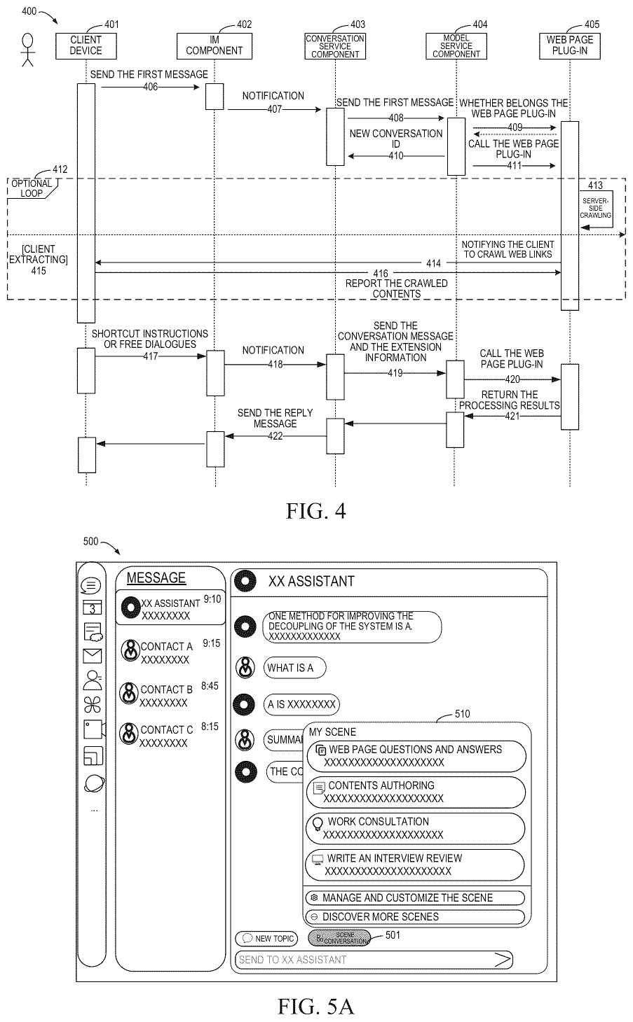

A specific manner in which the terminal device 110 performs interaction using the web page plug-in is described below with reference to FIG. 4. FIG. 4 illustrates a flowchart of a feed 400 of information interaction according to some embodiments of the disclosure. The client device 401 in FIG. 4 may correspond to the terminal device 110. An instant messaging (IM) component 402, a conversation service component 403, a model service component 404, and a web page plug-in 405 may run at server 130. As shown in FIG. 4, the client device 401 may receive, in an interaction window (for example, a main conversation window) between a user and a digital assistant, a first message including a first link of the first web page. The client device 401 may send (406) the received first message (i.e., a message with the first link of the first web page) to the IM component 402. The IM component 402 may send (407) a notification including at least the first message to the conversation service component 403 based on the first message. The notification may further include, for example, an instruction indicating to call the web page plug-in. The conversation service component 403 may send (408) the first message to the model service component 404 based on the received notification. The model service component 404 may, for example, call the model to perform a web page processing task. The model service component 404 may further call the web page plug-in 405 to perform a web page processing task.

Different web pages can include different types of contents, and the links may also be different types of links. In some embodiments, to ensure correctness of the called plug-in, before calling the web page plug-in 405, the model service component 404 may further provide the first link to the web page plug-in 405, so that the web page plug-in 405 determines (409) whether the first link belongs to a web page link that can be processed by the web page plug-in 405.

If the web page plug-in 405 determines that the first link is not a web page link that can be processed, the web page plug-in 405 may send a message to the model service component 404 indicating that the web page plug-in cannot be called. If the web page plug-in 405 determines that the first link is a web page link that can be processed, the web page plug-in 405 can send a message to the model service component 404 indicating that the web page plug-in can be called. In some embodiments, in a case that a scene selected by the user is scenes other than the web page processing scene or the scene is not selected by the user, the model service component 404 may further send (410) a new conversation identifier (for example, a new conversation ID) to the conversation service component 403. The model service component 404 may further, in response to receiving a message that may call the web page plug-in, determine that the web page plug-in is enabled, and send (411) a call instruction to the web page plug-in 405 to call the web page plug-in 405.

In some embodiments, in order to ensure the security and compliance of the data, it may also be determined (412) whether the web page plug-in 405 can directly crawl contents in the first web page from the first link, and this determination may also be referred to as an optional loop. For example, if the digital assistant is a digital assistant integrated in the application A, and the first web page is a web page provided by the application B, it may be determined that the web page plug-in 405 may not directly crawl contents in the first web page from the first link. If it is determined that the web page plug-in 405 can directly crawl contents in the first web page from the first link, the web page plug-in located in the server 130 (also referred to as a server-side) may directly crawl (412) the contents in the first web page from the first link at the server-side. If it is determined that the web page plug-in 405 does not directly crawl contents in the first web page from the first link, the web page plug-in 405 may notify (415) the client device 401 initiating the first message to crawl contents in the first web page from the first link. The client device 401 may crawl (414) the contents in the first web page based on the notification. The manner in which the client device 401 crawls the contents may also be referred to as a client extraction. The client device 401 may report (416) the crawled contents in the first web page to the web page plug-in 405. Thereby, the web page plug-in 405 may obtain the contents in the first web page.

The client device 401 may further receive a shortcut instruction triggered by the user or a free dialog from the user, where the free dialog here refers to a user input received by the client device 401 through an information collection component such as an input box or a microphone. The shortcut instruction and the free dialog may also be collectively referred to as a conversation messages from the user. The client device 401 may send (417) the received conversation message to the IM component 402. The IM component 402 can send (418) a notification including at least the conversation message to the conversation service component 403. The conversation service component 403 may determine its corresponding extension information based on the conversation message. The extension information may be, for example, a prompt (“prompt”) input determined based on the conversation message. The conversation service component 403 may send (419) the conversation message and the extension information to the model service component 404. The model service component 404 may send (420) a message to the web page plug-in 405 for calling the web page plug-in 705. The web page plug-in 405 may perform web page processing operations indicated by the conversation message based on the message and the previously obtained contents. The web page plug-in 405 returns (421) the processing results to the model service component 404. The model service component 404 forwards the processing results to the conversation service component 403. The conversation service component 403 may determine a reply message for the conversation message based on the processing results. The conversation service component 403 may send (422) a reply message to the IM component 402. The IM component 402 forwards the received reply message to the client device 401 so that the client device 401 can present the reply message in the interaction window between the user and the digital assistant.

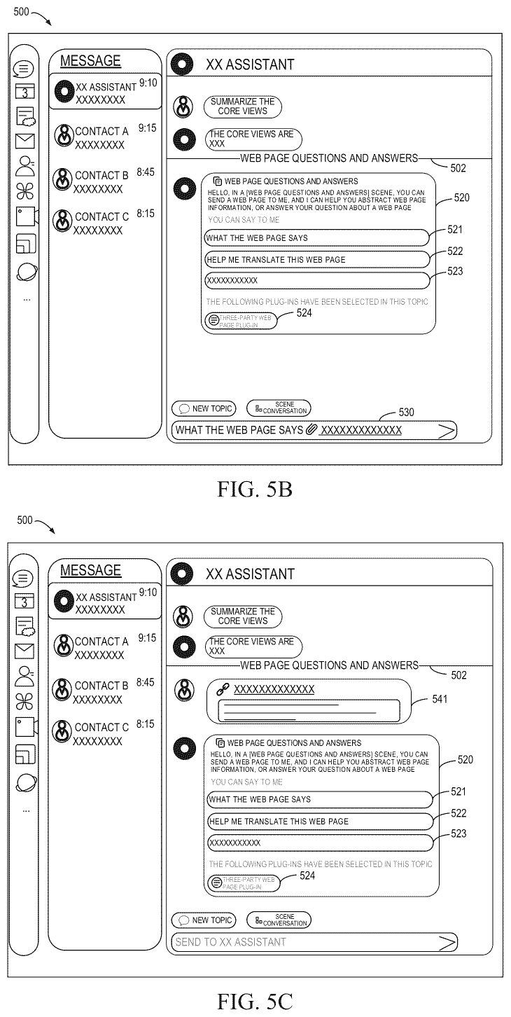

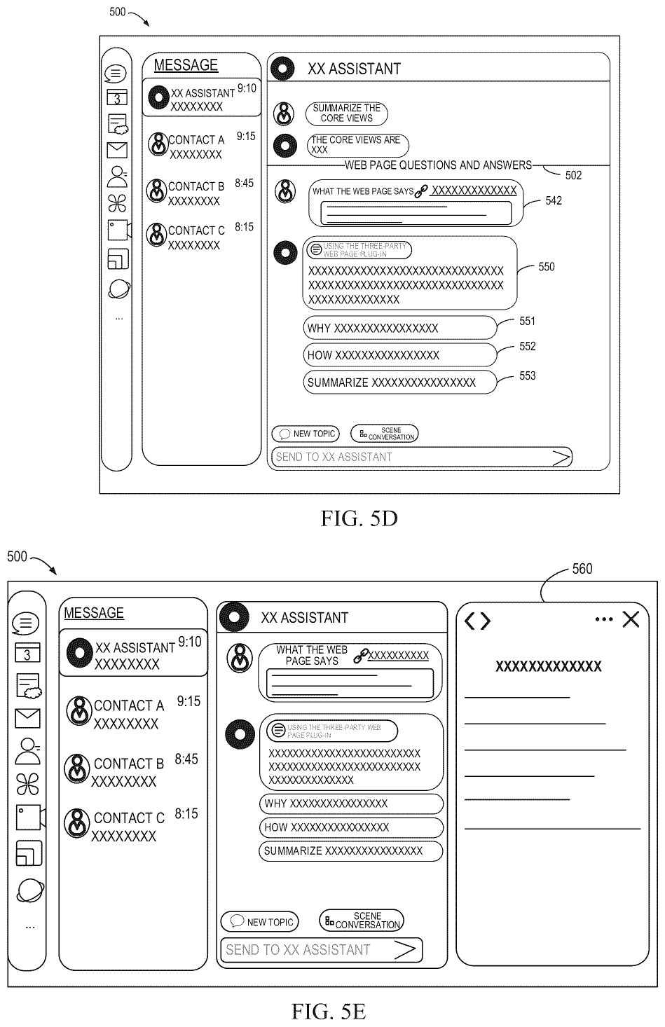

FIGS. 5A-5E illustrate schematic diagrams of an example client interface 500 of an interaction window according to some embodiments of the disclosure. The client interface 500 may be implemented at the terminal device 110. Examples of FIGS. 5A-5E are described below with reference to FIG. 1.

As shown in FIG. 5A, an operation control 501 for selecting a scene is presented in the interface 500. The terminal device 110 may present the window 510 in response to receiving a trigger operation on the operation control 501. A set of scenes may be presented in the window 510 (for example, the scene may include a scene “web page question and answer”, a scene “content authoring”, a scene “work consultation”, a scene “write face evaluation”, etc.) may be presented. An operational control (e.g., a control “manage and customize scenes”) for managing scenes and an operational control (e.g., a control “find more scenes”) for presenting more scenes may also be presented in the window 510. The terminal device 110 may determine to receive a selection of the scene in response to receiving a trigger operation on a certain scene in a set of scenes. It should be noted that the scene “web page question and answer” may be a scene related to web page processing. The terminal device 110 may determine, in response to receiving a trigger operation on the scene “web page question and answer”, that a selection of the scene “web page question and answer” is received and present the interface 500 as shown in FIG. 5B.

The interface 500 shown in FIG. 5B may include a segmentation line 502 for distinguishing the scene “web page question and answer” and a previous scene. The interface 500 may further include a message card 520 corresponding to the scene “web page question and answer”. The message card 520 may present guidance information associated with the scene “web page question and answer”. The guidance information may include scene guide information of the scene “web page question and answer”, at least one recommended question for the digital assistant in the scene “web page question and answer”, at least one shortcut instruction for the digital assistant in the scene “web page question and answer”, an indication of a plug-in used in the scene “web page question and answer”, and the like. As shown in FIG. 5B, the message card 520 is presented with scene guide information “hello, in a [web question and answer] scene, you can send a web page to me, and I can help you abstract web page information, or answer your question about a web page”, and at least one recommendation question (e.g., a recommendation question 521, a recommendation question 522, and a recommendation question 523) and the indication 524 of the plug-in. The indication 524 of the plug-in may indicate, for example, that the plug-in that is selected/enabled by default in the scene “web page question and answer” is a three-party web page plug-in (that is, a web page plug-in). An input box 530 is also presented in the interface 500. In a case where the scene “web page question and answer” is selected, the terminal device 110 may, for example, receive, via the input box 530, a first message that is input by the user and that includes at least a first link of the first web page.

In some embodiments, if the scene selected by the user is not the scene related to the web page processing, or the scene is not selected by the user, the terminal device 110 may switch to the web page processing scene in response to receiving the first message including the first link of the first web page in the conversation window. If the first message includes only the first link, the terminal device 110 may present the interface 500 shown in FIG. 5C. As shown in FIG. 5C, the terminal device 110 may determine, in response to receiving the first message 541 including the first link, a scene matched with the first message 541 as the scene “web page question and answer” and switch to the scene “web page question and answer”. If the first message further includes the first question for the first web page, the terminal device 110 may present the interface 500 shown in FIG. 5D. As shown in FIG. 5D, the terminal device 110 may determine, in response to receiving the first message 542 including the first link and the first question for the first web page, a scene matched with the first message 542 as the scene “web page question and answer” and switch to the scene “web page question and answer”. The terminal device 120 may further present a reply message 550 (also referred to as a “answer message”) for the first question. The reply message 550 is a first reply to the first question determined by the digital assistant based on the contents of the first web page. The reply message 550 may be presented with an indication that the digital assistant determines the plug-in used by the reply message. In some embodiments, the terminal device 110 may further present at least one recommendation instruction (for example, a recommendation instruction 551, a recommendation instruction 552, a recommendation instruction 553) to guide the user to continue to interact with the first web page. The recommendation instruction herein may also be determined by the digital assistant based on the contents of the first web page.

It may be understood that, in a case that the first message does not include the first question, the terminal device 110 may further receive a second message that includes the first question. The terminal device 110 may provide a first reply to the first question based on the contents of the first web page in response to the second message. The terminal device 110 may further present the first reply and at least one recommendation instruction in the interface 500.

In some embodiments, the terminal device 110 may further present contents in the first web page in a first region in response to detecting the trigger on the first link in the first message, where the first region is independent of the interaction window. For example, the terminal device 110 may determine, in response to detecting a click operation on the first link, that a trigger on the first link is received. The terminal device 110 may present, in response to receiving the trigger on the first link, the interface 500 shown in FIG. 5E. As shown in FIG. 5E, a region 560 is further presented in the interface 500, and the region 560 is used to present contents in the first web page. It should be noted that although the region 560 is located on the right side of the other region as an example for description in FIG. 5E, in other embodiments, the region 560 may also be arranged in other manners as needed. For example, the region 560 may be presented on the leftmost side in the client interface. For another example, the region 560 may also be presented in the form of a floating window. It may be understood that, in some embodiments, the terminal device 110 may further switch from the client interface including the interaction window to the client interface including the first region in response to detecting the trigger on the first link in the first message. In this case, the terminal device 110 may not present the interaction window and the first region at the same time.

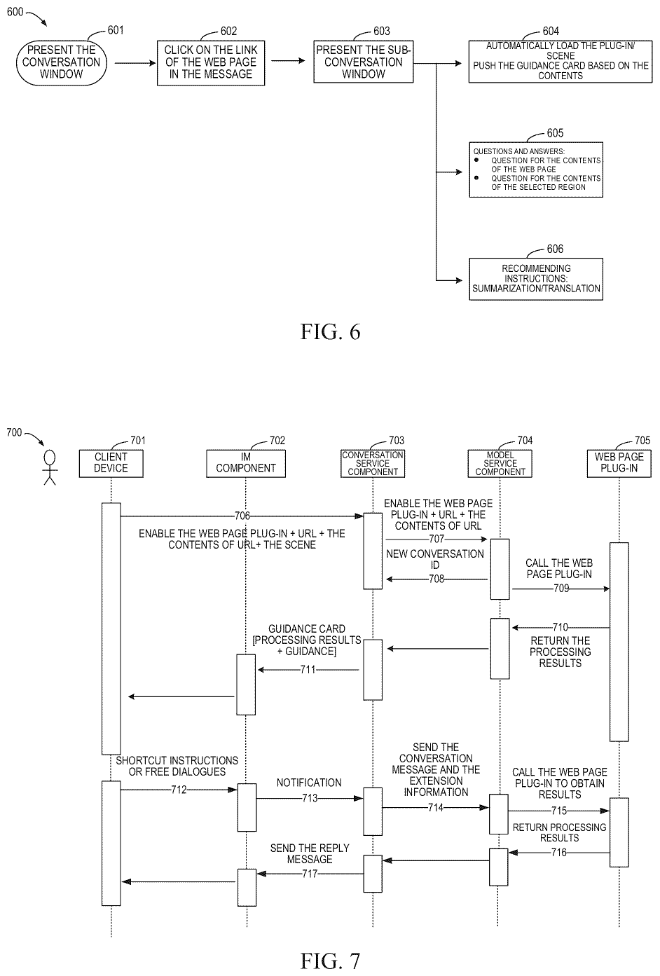

A plurality of examples of performing information interaction in an interaction window are described above. In an embodiment of the disclosure, the terminal device 110 may further perform information interaction based on a specific operation in the web page. A plurality of examples of performing information interaction based on specific operations in the web page are described below with continued reference to FIGS. 6-9. It can be understood that the web page herein should be a web page that can be opened in a case that the terminal device 110 conforms to rules.

FIG. 6 is a schematic diagram of a flow 600 of information interaction according to some other embodiments of the disclosure. As shown in FIG. 6, at block 601, the terminal device 110 may present a conversation window. The conversation window may include a conversation window between the user and the digital assistant, a private chat window between the user and the user, and a group chat window between the user and a set of users. The conversation window may include a conversation message sent by a user, other users, and/or a digital assistant. In some embodiments, there may be at least one conversation message that includes a link of a web page. The conversation message may be previously sent by the user, or sent by other users and/or a digital assistant.

At block 602, the terminal device 110 may determine to receive a trigger on the link in response to detecting the user clicking on the link of the web page (e.g., a first web page) in the conversation message. The terminal device 110 may present the contents of the first web page in a second region independent of the conversation window. The following is examples described by taking the terminal device 110 switching from the client interface including the interaction window to the client interface including the second region as an example. In this case, the terminal device 110 presents the contents of the first web page without presenting the conversation window. The terminal device 110 may present an invocation control of the digital assistant in such a client interface. At block 603, the terminal device 110 may present a sub-conversation window (that is, an interaction window) between the user and the digital assistant in response to the trigger on the invocation control. The presentation region of the interaction window is independent of the presentation region of the first web page.

The terminal device 110 may provide the contents in the first web page to the web page plug-in, and in the interaction window, perform the interaction between the user and the digital assistant based on the contents in the first web page using the web page plug-in. For example, the terminal device 110 may perform the interaction shown in blocks 604,605, and 606.

At block 604, the terminal device 110 may automatically load the plug-in/scene. For example, the terminal device 110 may determine, in response to a trigger on invocation control, a scene of interaction as a scene related to web page processing. That is, the terminal device 110 may determine that the scene related to the web page processing is selected for interaction in the interaction window in response to detecting the trigger on the invocation control while presenting the first web page. It may be understood that, in the sub-conversation window, the interaction between the user and the digital assistant is also based on configuration information of the scene (for example, configuration information of a scene related to web page processing) and contents in the first web page. Similarly, the terminal device 110 may determine that the web page plug-in is enabled in response to detecting a trigger on the invocation control while presenting the first web page. That is, the terminal device 110 may enable the web page plug-in by default in response to detecting a trigger on the invocation control while presenting the first web page. It may be understood that the terminal device 110 may further enable other plug-ins to perform interaction between the user and the digital assistant using the web page plug-in and other plug-ins. The terminal device 110 may, for example, present a guidance card in a sub-conversation window. The contents in the guidance card may be, for example, determined by the digital assistant based on contents in the first web page.

At block 605, the terminal device 110 may further perform a question-and-answer operation on the first web page. For example, the terminal device 110 may determine, in response to receiving a question for the web page content input by the user, a problem indicated by the question. The digital assistant, in turn, may determine a reply to the question based on the contents of the first web page. For example, the terminal device 110 may determine, in response to receiving a selection operation on a part of contents in the first web page content and a question input by the user for the part of contents, a problem indicated by the question. The digital assistant may, in turn, determine a reply to the question based at least on the selected part of contents.

At block 606, the terminal device 110 may further present at least one recommendation instruction in the sub-conversation window. The at least one recommendation instruction may, for example, indicate operations such as summarization, translation, and the like on the contents. The terminal device 110 may present the second recommendation instruction in the sub-conversation window in response to detecting a selection operation on a second recommendation instruction in at least one recommendation instruction. For example, the terminal device 110 may present the second recommendation instruction in the conversation window in a form of a conversation message from the user and perform the web page processing task indicated by the second recommendation instruction using the web page plug-in based on the second recommendation instruction.

A specific manner in which the terminal device 110 performs interaction using the web page plug-in is described below with reference to FIG. 7. FIG. 7 illustrates a flowchart of a feed 700 of information interaction according to some other embodiments of the disclosure. The client device 701 in FIG. 7 may correspond to the terminal device 110, an instant messaging (IM) component 702, a conversation service component 703, a model service component 704, and a web page plug-in 705 may run at server 130. The client device 701 may present an invocation control of the first web page and the digital assistant in the client interface. The terminal device 110 may send (706) a message to the conversation service component 703 in response to detecting a trigger on the invocation control, the message including the enabled web page plug-in, the link of the first web page (i.e., the URL), the contents of the first web page, and an indication that the scene is a scene associated with the web page processing. The conversation service component 707 may determine, based on the message, that the conversation scene is a scene related to web page processing, and send (707), to the model service component 704, a message including the enabled web page plug-in, the link (i.e., the URL) of the first web page, and the contents of the first web page. The model service component 704 can send (708) a new conversation identifier (e.g., a new conversation ID) to the conversation service component 703 based on the received message. The model service component 704 may also send (709) a call instruction to the web page plug-in 705 to call the web page plug-in 705.

In some embodiments, the terminal device 110 may further present, in response to a trigger on the invocation control, the guidance information in the conversation window, where the guidance information includes at least one recommendation instruction for the digital assistant, and the at least one recommendation instruction is determined based on contents in the first web page. The guidance information may be determined by processing the content in the first web page using the web page plug-in 705. The web page plug-in 705 may send (710) the processing results of the contents in the first web page to the model service component 704, and the model service component 704 forwards the received processing results to the conversation service component 703. The conversation service component 703 may determine the guidance card based on the processing results, for example. The guidance card may include a processing results and guidance information. The conversation service component 703 sends (711) the guidance card to the IM component 702, which in turn sends the guidance card to the client device 701 so that the client device 701 can present the guidance card.

The client device 701 may further receive a shortcut instruction triggered by the user or a free dialog from the user, where the free dialog here refers to a user input received by the client device 701 through an information collection component such as an input box or a microphone. The shortcut instruction and the free dialog may also be collectively referred to as a conversation message from the user. The client device 701 may send (712) the received conversation message to the IM component 702. The IM component 702 can send (713) a notification including at least the conversation message to the conversation service component 703. The conversation service component 703 may determine its corresponding extension information based on the conversation message. The extension information may be, for example, a prompt (“prompt”) input determined based on the conversation message. The conversation service component 703 may send (714) the conversation message and the extension information to the model service component 704. The model service component 704 can send (715) a message to the web page plug-in 705 to call the web page plug-in 705. The web page plug-in 705 may perform the web page processing operations indicated by the conversation message based on the message and the previously obtained contents. The web page plug-in 705 returns (716) the processing results to the model service component 704. The model service component 704 forwards the processing results to the conversation service component 703. The conversation service component 703 may determine a reply message for the conversation message based on the processing results. The conversation service component 703 may send (717) a reply message to the IM component 702. The IM component 702 forwards the received reply message to the client device 701 so that the client device 701 can present the reply message in a conversation window between the user and the digital assistant.

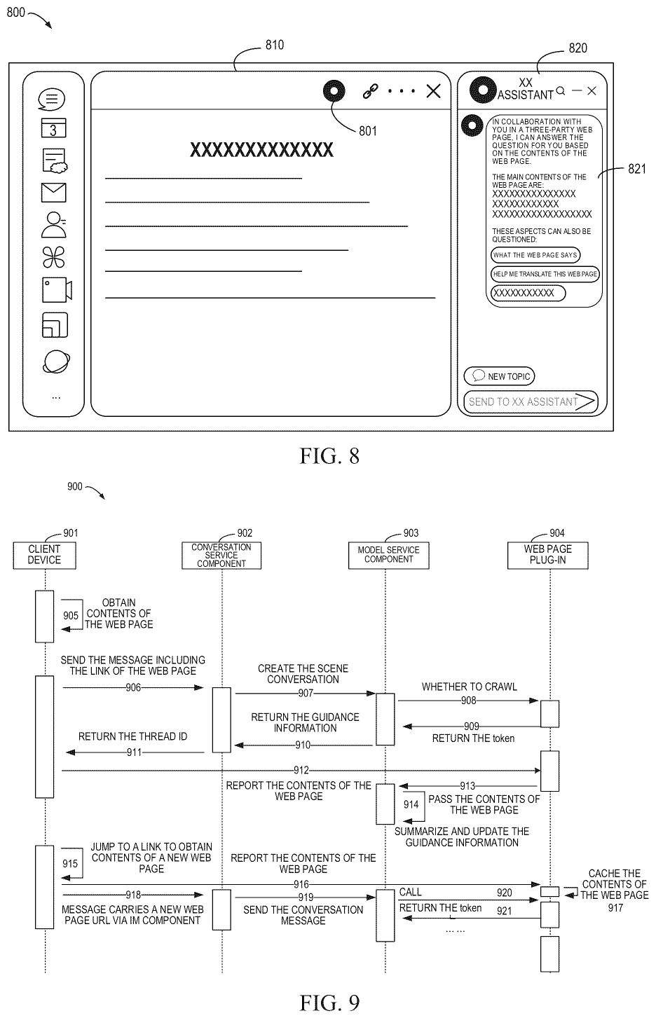

FIG. 8 illustrates a schematic diagram of an example client interface 800 of an interaction window according to some other embodiments of the disclosure. The client interface 800 may be implemented at the terminal device 110. The example of FIG. 8 is described below with reference to FIG. 1. As shown in FIG. 8, the interface 800 includes a region 810 for presenting contents of the first web page. The region 810 includes an interaction control 801 for the digital assistant. In response to detecting a trigger on the interaction control 801, the terminal device 110 detects that the digital assistant is triggered for an interaction event based on the first web page, as in this case that the digital assistant is invoked in the context of presenting the first web page. In this case, because the contents in the first web page have been obtained at the terminal device 110 for presentation, the terminal device 110 may correspondingly provide the contents in the first web page to the web page plug-in. In this way, the interaction between the user and the digital assistant can be performed using the web page plug-in based on the contents in the second web page in the interaction window between the user and the digital assistant.

In response to detecting a trigger on interaction control 801, red end device 110 presents a region 820. The region 820 is used to present a conversation window between the user and the digital assistant. It should be noted that although the region 820 is located on the right side of the region 810 as an example for description in FIG. 8, in other embodiments, the region 820 may further be arranged in other manners as needed. For example, the region 820 may be presented to the left side of the region 810 in a client interface. For another example, the region 820 may also be presented in the form of a floating window.

In some embodiments, in response to detecting a switch from the first web page to the second web page while the interaction window is presented, the terminal device 110 may further obtain and present contents in the second web page. The terminal device 110 may provide the contents in the second web page to the web page plug-in, and in the interaction window, perform the interaction between the user and the digital assistant based on the contents in the second web page using the web page plug-in.

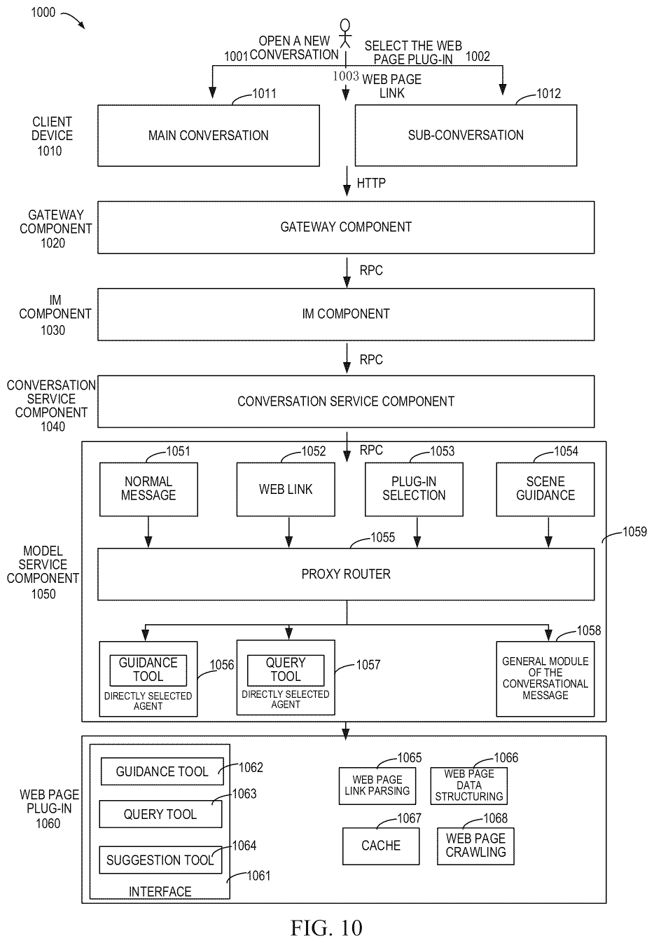

FIG. 9 illustrates a flowchart of a feed 900 of a web page jump according to some embodiments of the disclosure. The client device 901 in FIG. 9 may correspond to the terminal device 110, and a conversation service component 902, a model service component 903, and a web page plug-in 904 may run at the server 130. The terminal device 110 may obtain (905) contents of a currently presented first web page. The terminal device 110 may further present a sub-conversation window between the user and the digital assistant in response to detecting a trigger on the invocation control while presenting the first web page. The terminal device 110 may further receive, in the sub-conversation window, a conversation message that is sent by the user and has a link of the second web page. The terminal device 110 may send (906) the received conversation message including the link of the second web page to the conversation service component 902. The conversation service component 902 can send (907) a message to the model service component 903 indicating a creation of a scene conversation based on the received conversation message.

The model service component 903 may send (908) a link of the second web page to the web page plug-in 904 based on the received message and a message indicating whether to crawl or not. The web page plug-in 904 may determine, based on the received message and the link of the second web page, whether the contents of the second web page may be crawled. The web page plug-in 904 in turn returns (909) the determined results of to the model service component 903. The determined results may include, for example, a token (“token”) indicating whether to crawl. The model service component 903 may determine guidance information based on the received determined results. The model service component 903 can, for example, return (910) the guidance information to the conversation service component 902. The conversation service component 902 can return (911) a thread identifier (e.g., thread ID) to the client device 901. The client device 901 may report (912) the contents of the web page (for example, including the contents of the first web page and the contents of the second web page) to the web page plug-in 904. The web page plug-in 904 may, for example, pass (913) the contents of the received web page to the model service component 903. The model service component 903 may perform operations such as contents summarization based on the contents of the web page, and update (914) the guidance information.

For example, the client device 901 may jump (915) to presenting the contents in the second web page in response to detecting a click operation on the link of the second web page. The client device 901 may report (912) the contents of the web page (e.g., the contents of the second web page) to the web page plug-in 904. The web page plug-in 904 may cache (917) the contents of the received web page, for example. The client device 901 may further send (918) the received conversation message (i.e., a message with a link of the second web page) to the conversation service component 902 via the IM component. The conversation service component 902 may send (919) the received conversation message to the model service component 903. The model service component 903 also call (920) the web page plug-in 904 to perform web page processing tasks. Different types of contents may be included in different web pages, and the links may also be different types of links. In some embodiments, to ensure the correctness of the called plug-in, the model service component 903 may further provide the first link to the web page plug-in 904, so that the web page plug-in 904 determines whether the link of the second web page belongs to a web page link that can be processed by the web page plug-in 904. The web page plug-in 904 may send (921) determined results indicating whether the link of the second web page belongs to a web page link that can be processed by the web page plug-in 904 to the model service component 903. Similarly, the determined results sent by the web page plug-in 904 may be a token indicating whether the link of the second web page belongs to the web page link that can be processed by the web page plug-in 904. Subsequent steps may refer to steps 409 to 422 in the feed 400, and details are not described herein again.

FIG. 10 illustrates an example 1000 of an architecture of information interaction according to some embodiments of the disclosure. As shown in FIG. 10, the architecture 1000 may include a client device 1010, a gateway component 1020, an IM component 1030, a conversation service component 1040, a model service component 1050, and a web page plug-in 1060. The client device 1010 herein may correspond to, for example, the terminal device 110, and the gateway component 1020, the IM component 1030, the conversation service component 1040, the model service component 1050, and the web page plug-in 1060 may run on the server 130.

As shown in FIG. 10, the client device 1010 may present a main conversation window 1011 corresponding to a main conversation and a sub-conversation window 1012 corresponding to a sub-conversation. The client device 1010 may receive various operations from the user in the main conversation window 1011 and/or the sub-conversation window 1012, such as an operation of opening a new conversation (1001), an operation of selecting the web page plug-in (1002) and the like. The client device 1010 may further receive a conversation message from the user including a link (also referred to simply as a web page link) of the web page in the main conversation window 1011 and/or the sub-conversation window 1012.

The client device 1010 may, for example, send the received conversation message including the web page link to the gateway component 1020 based on any appropriate communication protocol, such as a HTTP protocol. The gateway component 1020 may likewise send a conversation message including a web page link to the IM component 1030, for example, based on any appropriate communication protocol, such as a RPC protocol. The IM component 1030 may likewise send a conversation message including a web page link to the conversation service component 1040, for example, based on any appropriate communication protocol, such as a RPC protocol. The conversation service component 1040 may likewise send a conversation message including the web page link to the model service component 1050 based on any appropriate communication protocol, such as a RPC protocol.

The model service component 1050 may, for example, perform processing tasks associated with a normal message 1051, a web link 1052, a plug-in selection 1053, a scene guidance 1054, and the like. The model service component 1050 may further include, for example, a proxy router 1055. The model service component 1050 can determine at least one directly selected agent (e.g., directly selected agent 1056 and directly selected agent 1057) based on the tasks to be performed. Each directly selected agent may include a guidance tool. The model service component 1050 may further include a general module 1058 of the conversational message. The model service component 1050 may, for example, perform a reply to the message of the user based on the directly selected agent and the general module. The model service component 1050 may also perform web page processing operations by calling the web page plug-in 1060.

The web page plug-in 1060 may include an interface 1061. The interface 1061 may include a guidance tool 1062, a query tool 1063, and a suggestion tool 1064. The guidance tool 1062 may be, for example, a tool for determining guidance information based on web page contents. The query tool 1063 may be, for example, a tool for querying contents in a web page. The suggestion tool 1064 may, for example, be a tool used to give suggest to the next interaction of the user during the process of interaction. The web page plug-in 1060 may further include a web page link parsing module 1065, a web page data structuring module 1066, a cache module 1067, and a web page crawling module 1068. By means of the four modules, the web page plug-in may have a web page link parsing function, a web page content structured function, a content caching function, and a web page crawler function.

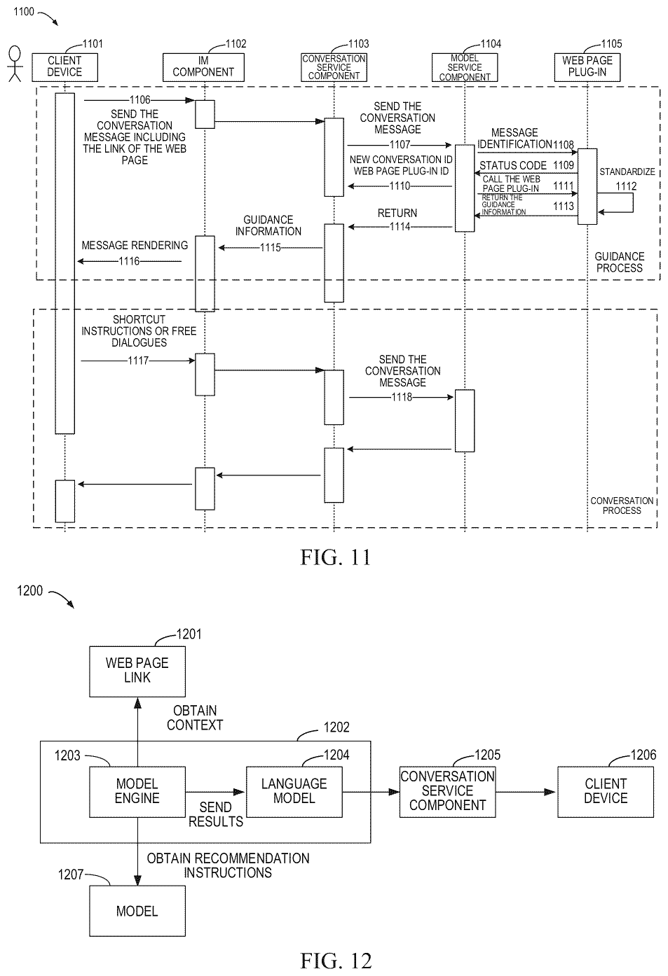

The interface 1061 of the web page plug-in 1060 may perform a guidance process (which may also be referred to as an “Onboarding” process) to ensure that other modules in the web page plug-in 1060 may perform corresponding functions. FIG. 11 illustrates an example of information interaction according to some embodiments of the disclosure. As shown in FIG. 11, the client device 1101 may send (1106) a conversation message with a web page link to the IM component 1102. The conversation service component 1103 can obtain a conversation message with the web page link forwarded via the IM component and send (1107) it to the model service component 1104. The model service component 1104 can provide the web page link in the conversation message to the web page plug-in 1105 and send (1108) a message to the web page plug-in 1105 indicating whether the web page link belongs to a web page link that can be processed by the web page plug-in 1105. Such a message may, for example, indicate the web page plug-in 1105 to perform message identification on the received web page link. The web page plug-in 1105 may generate a status code indicating the determined results and send (1109) it to the model service component 1104. The model service component 1104 may determine, based on the status code, whether the web page link belongs to a web page link that may be processed by the web page plug-in 1105, and further determine whether to call the web page plug-in 1105.

If it is determined that the web page plug-in can be called, the model service component 1104 can also send (1110) a message to the conversation service component 1103 that includes a new conversation identifier (e.g., a new conversation ID) and an identifier of the called web page plug-in 1105 (e.g., a web page plug-in ID). The model service component 1104 may further send (1111) a call instruction that calls the web page plug-in to the web page plug-in 105 to call the web page plug-in 1105. The web page plug-in 1105 may perform (1112) a guidance process to determine guidance information in response to receiving the call instruction. In the process of performing the guidance process by the web page plug-in 1105, a unique token may be determined, which may be used to correspond to the context of the contents obtained by the web page plug-in 1105. The web page plug-in 1105 may send the token to the model service component 1104.

The web page plug-in 1105 may return (1113) the guidance information to the model service component 1104. The model service component 1104 returns (1114) the guidance message to the conversation service component 1103. The conversation service component 1103 may send (1115) the received guidance message to the IM component 1102. The IM component 1102 may send (1106) the guidance message along with instructions indicating the client device 1101 to perform message rendering (1106) to the client device 1101. After receiving the instructions, the client device 1101 may render the received guidance message to the client interface to present it to the user.

During the process of the conversation, the client device 1101 may receive a shortcut instruction or a free dialog (also referred to as a conversation message) of the user and send (1117) the received conversation message to the IM component 1102. The conversation service component 1103 can receive the conversation message forwarded by the IM component 1102 and send it to the model service component 1104. In some embodiments, the conversation service component 1103 may further send an identifier of the web page plug-in to indicate the model service component 1104 to call the web page plug-in to perform the web page processing. The model service component 1104 can provide the processing results to the client device 1101 via the forwarding of the conversation service component 1103 and the IM component 1102.

FIG. 12 illustrates a schematic diagram of a framework 1200 for determining a recommendation instruction according to some embodiments of the disclosure. The framework 1200 includes a web page link 1201, a model service component 1202, a conversation service component 1205, a client device 1206, and a model 1207. The model service component 1202 includes a model engine 1203 and a language model 1204. In some embodiments, after the web page plug-in performs the guidance process, an unique token determined by performing the guidance process may be provided to the model service component 1202. The model engine 1203 in the model service component 1202 may obtain contextual information in the web page corresponding to the web page link 1201 based on the token. The model engine 1203 of the model service component 1202 may further obtain at least one recommendation instruction from the model 1207. For example, the model engine 1203 may provide the obtained context information to the model 1207 and obtain the at least one recommendation instruction determined by the model 1207 based on the context information. The model engine 1203 may further send the obtained at least one recommended instruction to the language model 1204. The language model 1204 sends at least one recommendation instruction to the conversation service component 1205. The conversation service component 1205, in turn, provides at least one recommendation instruction to the client device 1206.

In conclusion, according to the embodiments of the disclosure, the web page plug-in may be used, so that the digital assistant may obtain the contents in a third-party web page and perform interaction based on the contents, which not only enlarges the application scene of the digital assistant, but also helps to reduce the difficulty and complexity of interaction between the user and the digital assistant, and improve the interaction efficiency.

### Example Processes

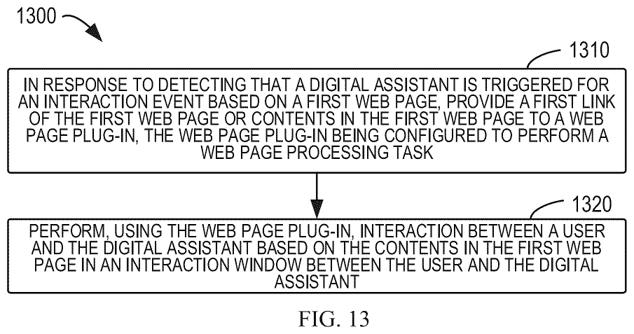

FIG. 13 illustrates a flowchart of a process 1300 for information interaction according to some embodiments of the disclosure. Process 1300 may be implemented at the terminal device 110. For ease of discussion, the process 1300 will be described with reference to the environment 100 of FIG. 1.

At block 1310, the terminal device 110 provides a first link of the first web page or contents in the first web page to a web page plug-in in response to detecting that a digital assistant is triggered for an interaction event based on a first web page, the web page plug-in being associated with the digital assistant, and the web page plug-in being configured to perform a web page processing task.

At block 1320, the terminal device 110 performs, using the web page plug-in, interaction between a user and the digital assistant based on the contents in the first web page in an interaction window between the user and the digital assistant.

In some embodiments, the process 1300 further comprises: receiving a first message in the interaction window between the user and the digital assistant, the first message including the first link of the first web page; and in response to receiving the first message, detecting that the digital assistant is triggered for the interaction event based on the first web page. In this case, in response to receiving the first message, providing the first link of the first web page to the web page plug-in, so that obtaining, by the web page plug-in, the contents in the first web page from the first link.

In some embodiments, obtaining, by the web page plug-in, the contents in the first web page from the first link comprises: crawling, by the web page plug-in, the contents in the first web page from the first link; or notifying, by the web page plug-in, a client device initiating the first message to crawl the contents in the first web page from the first link, the contents in the first web page crawled by the client device being reported to the web page plug-in.

In some embodiments, the process 1300 further comprises: determining that the web page plug-in is enabled in the interaction between the user and the digital assistant based on the first message including the first link.

In some embodiments, determining that the web page plug-in is enabled comprises: determining whether the web page plug-in is configured to process a link type corresponding to the first link; and determining that the web page plug-in is enabled based on determining that the web page plug-in is configured to process the link type corresponding to the first link.

In some embodiments, determining that the web page plug-in is enabled comprises: in response to receiving the first message in a scenario where a scene related to web page processing is selected for interaction, determining that the web page plug-in is enabled; or in response to receiving the first message, determining that the scene related to the web page processing is selected and the web page plug-in is enabled based on the first message.

In some embodiments, the interaction between the user and the digital assistant is based on configuration information of the scene and the contents in the first web page.

In some embodiments, performing the interaction between the user and the digital assistant comprises at least one of: in response to the first message including a first question or receiving a first question for the first web page, providing a first reply for the first question based on the contents in the first web page; presenting at least one recommendation instruction for the digital assistant in the interaction window, the at least one recommendation instruction being determined based on the contents in the first web page; or in response to detecting a trigger on the first link in the first message, presenting the contents in the first web page in a first region, the first region being independent of the interaction window.

In some embodiments, the web page plug-in comprises at least one of the following functions: web page link parsing function, web page contents structuring function, contents caching function, or web page crawler function.

In some embodiments, the process 1300 further comprises: presenting the contents in the first web page and an invocation control of the digital assistant; and in response to a trigger on the invocation control, detecting that the digital assistant is triggered for the interaction event based on the first web page. In this case, in response the trigger on the invocation control, providing the obtained first link of the first web page to the web page plug-in.

In some embodiments, the process 1300 further comprises: in response to detecting the trigger on the invocation control while presenting the contents in the first web page, determining that the web page plug-in is enabled in the interaction between the user and the digital assistant.

In some embodiments, the process 1300 further comprises: in response to detecting the trigger on the invocation control while presenting the contents in the first web page, determining that a scene related to the web page processing is selected for interaction in the interaction window, and wherein the interaction between the user and the digital assistant is based on configuration information of the scene and the contents in the first web page.

In some embodiments, the process 1300 further comprises: in response to the trigger on the invocation control, presenting the interaction window between the user and the digital assistant and presenting guidance information in the interaction window, the guidance information including at least one recommendation instruction for the digital assistant, the at least one recommendation instruction being determined based on the contents in the first web page.

In some embodiments, a presentation region of the interaction window between the user and the digital assistant is independent of a presentation region of the first web page.

In some embodiments, the process 1300 further comprises: in response to detecting a switch from the first web page to a second web page while the interaction window is presented, presenting contents in the second web page; providing the contents in the second web page to the web page plug-in; and performing, in the interaction window, the interaction between the user and the digital assistant based on the contents in the second web page using the web page plug-in.

### Example Apparatus and Device

Embodiments of the disclosure also provide a corresponding apparatus for implementing the above method or process.

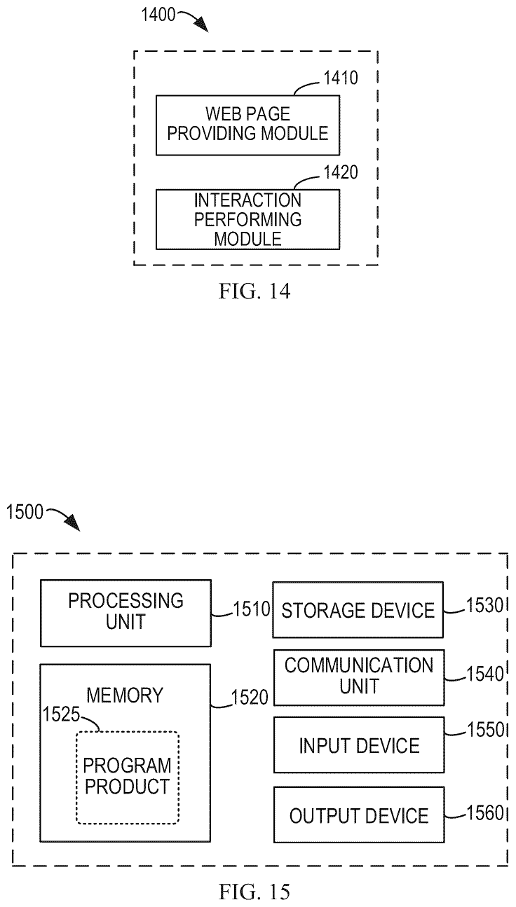

FIG. 14 illustrates a schematic structural block diagram of an apparatus 1400 for information interaction according to some embodiments of the disclosure. The apparatus 1400 may be implemented, for example, in or included in the terminal device 110. The various modules/components in the apparatus 1400 may be implemented by hardware, software, firmware, or any combination thereof.

As shown, the apparatus 1400 comprises: a web page providing module 1410 configured to in response to detecting that a digital assistant is triggered for an interaction event based on a first web page, provide a first link of the first web page or contents in the first web page to a web page plug-in, the web page plug-in being configured to perform a web page processing task. The apparatus 1400 further comprises: an interaction performing module 1420 configured to perform, using the web page plug-in, interaction between a user and the digital assistant based on contents in the first web page in an interaction window between the user and the digital assistant.

In some embodiments, the web page providing module 1410 further comprises: a message receiving module configured to receive a first message in the interaction window between the user and the digital assistant, the first message comprising the first link of the first web page; and a message-based trigger module configured to in response to receiving the first message, detecting that the digital assistant is triggered for the interaction event based on the first web page. In some embodiments, in response to receiving the first message, providing the first link of the first web page to the web page plug-in, so that obtaining, by the web page plug-in, the contents in the first web page from the first link.

In some embodiments, the web page providing module 1410 comprises: a plug-in extracting module configured to crawl, by the web page plug-in, the contents in the first web page from the first link, or a crawl notifying module configured to notify, by the web page plug-in, a client device initiating the first message to crawl the contents in the first web page from the first link, the contents in the first web page crawled by the client device being reported to the web page plug-in.

In some embodiments, the apparatus 1400 further comprises: an enabling determining module configured to determine that the web page plug-in is enabled in the interaction between the user and the digital assistant based on the first message including the first link.

In some embodiments, the enabling determining module is further configured to determine whether the web page plug-in is configured to process a link type corresponding to the first link; and determine that the web page plug-in is enabled based on determining that the web page plug-in is configured to process the link type corresponding to the first link.

In some embodiments, the enabling determination module is further configured to in response to receiving the first message in a scenario where a scene related to web page processing is selected for interaction, determine that the web page plug-in is enabled; or in response to receiving the first message, determine that the scene related to the web page processing is selected and the web page plug-in is enabled based on the first message.

In some embodiments, the interaction between the user and the digital assistant is based on configuration information of the scene and the contents in the first web page.

In some embodiments, the apparatus 1400 further comprises: a reply determining module configured to in response to the first message including a first question or receiving a first question for the first web page, provide a first reply for the first question based on the contents in the first web page; a recommendation instruction module configured to present at least one recommendation instruction for the digital assistant in the interaction window, the at least one recommendation instruction being determined based on the contents in the first web page; or a web page presenting module configured to in response to detecting a trigger on the first link in the first message, present the contents in the first web page in a first region, the first region being independent of the interaction window.

In some embodiments, the web page plug-in comprises at least one of the following functions: web page link parsing function, web page contents structuring function, contents caching function, or web page crawler function.

In some embodiments, the apparatus 1400 further comprises: a web page presenting module configured to present the contents in the first web page and an invocation control of the digital assistant; and an invocation-based interaction module configured to in response to a trigger on the invocation control, detect that the digital assistant is triggered for the interaction event based on the first web page. In some embodiments, in response the trigger on the invocation control, provide the obtained first link of the first web page to the web page plug-in.

In some embodiments, the apparatus 1400 further comprises: an enabling determining module configured to in response to detecting the trigger on the invocation control while presenting the contents in the first web page, determine that the web page plug-in is enabled in the interaction between the user and the digital assistant.

In some embodiments, the apparatus 1400 further comprises: a scene determining module, configured to in response to detecting the trigger on the invocation control while presenting the contents in the first web page, determine that a scene related to the web page processing is selected for interaction in the interaction window. The interaction between the user and the digital assistant is based on configuration information of the scene and the contents in the first web page.

In some embodiments, the apparatus 1400 further comprises: a window presenting module configured to in response to the trigger on the invocation control, present the interaction window between the user and the digital assistant and present guidance information in the interaction window, the guidance information including at least one recommendation instruction for the digital assistant, the at least one recommendation instruction being determined based on the contents in the first web page.

In some embodiments, a presentation region of the interaction window between the user and the digital assistant is independent of a presentation region of the first web page.

In some embodiments, the apparatus 1400 further comprises: a switching presenting module configured to in response to detecting a switch from the first web page to a second web page while the interaction window is presented, present contents in the second web page; and a providing module configured to provide the contents in the second web page to the web page plug-in. The interaction performing module 1420 is configured to perform, in the interaction window, the interaction between the user and the digital assistant based on the contents in the second web page using the web page plug-in.

The units and/or modules included in the apparatus 1400 may be implemented in various forms, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 1400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more steps of the above methods may be performed by an appropriate electronic device or a combination of electronic devices. Such electronic devices or a combination of electronic devices may include, for example, the server 130, the terminal device 110, and/or a combination of the server 130 and the terminal device 110 in FIG. 1.

FIG. 15 illustrates a block diagram of an electronic device 1500 in which one or more embodiments of the disclosure may be implemented. It should be understood that the electronic device 1500 shown in FIG. 15 is merely an example and should not constitute any limitation on the function and scope of the embodiments described herein. The electronic device 1500 shown in FIG. 15 may be configured to implement the terminal device 110 and/or the server 120 in FIG. 1, or the apparatus in FIG. 14.

As shown in FIG. 15, the electronic device 1500 is in the form of a general-purpose electronic device. Components of the electronic device 1500 may include, but are not limited to, one or more processors or processing units 1510, a memory 1520, a storage device 1530, one or more communication units 1540, one or more input devices 1550, and one or more output devices 1560. The processing unit 1510 may be an actual or virtual processor and capable of performing various processes according to programs stored in the memory 1520. In multiprocessor systems, multiple processing units execute computer-executable instructions in parallel to improve parallel processing capabilities of electronic device 1500.

The electronic device 1500 typically includes a plurality of computer storage media. Such media may be any available media accessible by the electronic device 1500, including, but not limited to, volatile and non-volatile media, removable and non-removable media. The memory 1520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1530 may be a removable or non-removable medium and may include a machine-readable medium, such as a flash drive, magnetic disk, or any other medium, which may be capable of storing information and/or data and may be accessed within electronic device 1500.

The electronic device 1500 may further include additional removable/non-removable, volatile/non-volatile storage media. Although not shown in FIG. 15, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1520 may include a computer program product 1525 having one or more program modules configured to perform various methods or actions of various embodiments of the disclosure.

The communications unit 1540 implements communications with other electronic devices over a communications medium. Additionally, the functionality of components of the electronic device 1500 may be implemented in a single computing cluster or multiple computing machines capable of communicating over a communication connection. Thus, the electronic device 1500 may operate in a networked environment using logical connections with one or more other servers, network personal computers (PCs), or another network node.

The input device 1550 may be one or more input devices, such as a mouse, a keyboard, a trackball, or the like. The output device 1560 may be one or more output devices, such as a display, a speaker, a printer, or the like. The electronic device 1500 may also communicate with one or more external devices (not shown) through the communication unit 1540 as needed, external devices such as storage devices, display devices, etc., communicate with one or more devices that enable a user to interact with the electronic device 1500, or communicate with any device (e.g., a network card, a modem, etc.) that enables the electronic device 1500 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

I/we claim:

1. A method of information interaction, comprising:
in response to detecting that a digital assistant is triggered for an interaction event based on a first web page, providing a first link of the first web page or contents in the first web page to a web page plug-in, the web page plug-in being configured to perform a web page processing task; and
performing, using the web page plug-in, interaction between a user and the digital assistant based on the contents in the first web page in an interaction window between the user and the digital assistant.

2. The method of claim 1, further comprising:
receiving a first message in the interaction window between the user and the digital assistant, the first message including the first link of the first web page; and
in response to receiving the first message, detecting that the digital assistant is triggered for the interaction event based on the first web page, and
wherein in response to receiving the first message, providing the first link of the first web page to the web page plug-in, so that obtaining, by the web page plug-in, the contents in the first web page from the first link.

3. The method of claim 2, wherein obtaining, by the web page plug-in, the contents in the first web page from the first link comprises:
crawling, by the web page plug-in, the contents in the first web page from the first link; or
notifying, by the web page plug-in, a client device initiating the first message to crawl the contents in the first web page from the first link, the contents in the first web page crawled by the client device being reported to the web page plug-in.

4. The method of claim 2, further comprising:
determining that the web page plug-in is enabled in the interaction between the user and the digital assistant based on the first message including the first link.

5. The method of claim 4, wherein determining that the web page plug-in is enabled comprises:
determining whether the web page plug-in is configured to process a link type corresponding to the first link; and
determining that the web page plug-in is enabled based on determining that the web page plug-in is configured to process the link type corresponding to the first link.

6. The method of claim 4, wherein determining that the web page plug-in is enabled comprises:
in response to receiving the first message in a scenario where a scene related to web page processing is selected for interaction, determining that the web page plug-in is enabled; or
in response to receiving the first message, determining that the scene related to the web page processing is selected and the web page plug-in is enabled based on the first message.

7. The method of claim 6, wherein the interaction between the user and the digital assistant is based on configuration information of the scene and the contents in the first web page.

8. The method of claim 1, wherein performing the interaction between the user and the digital assistant comprises at least one of:
in response to the first message including a first question or receiving a first question for the first web page, providing a first reply for the first question based on the contents in the first web page;
presenting at least one recommendation instruction for the digital assistant in the interaction window, the at least one recommendation instruction being determined based on the contents in the first web page; or
in response to detecting a trigger on the first link in the first message, presenting the contents in the first web page in a first region, the first region being independent of the interaction window.

9. The method of claim 1, wherein the web page plug-in comprises at least one of the following functions:
web page link parsing function,
web page contents structuring function,
contents caching function, or
web page crawler function.

10. The method of claim 1, further comprising:
presenting the contents in the first web page and an invocation control of the digital assistant; and
in response to a trigger on the invocation control, detecting that the digital assistant is triggered for the interaction event based on the first web page, and
wherein in response the trigger on the invocation control, providing the obtained first link of the first web page to the web page plug-in.

11. The method of claim 10, further comprising:
in response to detecting the trigger on the invocation control while presenting the contents in the first web page, determining that the web page plug-in is enabled in the interaction between the user and the digital assistant.

12. The method of claim 10, further comprising:
in response to detecting the trigger on the invocation control while presenting the contents in the first web page, determining that a scene related to the web page processing is selected for interaction in the interaction window, and
wherein the interaction between the user and the digital assistant is based on configuration information of the scene and the contents in the first web page.

13. The method of claim 10, further comprising:
in response to the trigger on the invocation control, presenting the interaction window between the user and the digital assistant and presenting guidance information in the interaction window, the guidance information including at least one recommendation instruction for the digital assistant, the at least one recommendation instruction being determined based on the contents in the first web page.

14. The method of claim 10, wherein a presentation region of the interaction window between the user and the digital assistant is independent of a presentation region of the first web page.

15. The method of claim 10, further comprising:
in response to detecting a switch from the first web page to a second web page while the interaction window is presented, presenting contents in the second web page;
providing the contents in the second web page to the web page plug-in; and
performing, in the interaction window, the interaction between the user and the digital assistant based on the contents in the second web page using the web page plug-in.

16. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
in response to detecting that a digital assistant is triggered for an interaction event based on a first web page, providing a first link of the first web page or contents in the first web page to a web page plug-in, the web page plug-in being configured to perform a web page processing task; and
performing, using the web page plug-in, interaction between a user and the digital assistant based on the contents in the first web page in an interaction window between the user and the digital assistant.

17. The electronic device of claim 16, the acts further comprising:
receiving a first message in the interaction window between the user and the digital assistant, the first message including the first link of the first web page; and
in response to receiving the first message, detecting that the digital assistant is triggered for the interaction event based on the first web page, and
wherein in response to receiving the first message, providing the first link of the first web page to the web page plug-in, so that obtaining, by the web page plug-in, the contents in the first web page from the first link.

18. The electronic device of claim 17, wherein obtaining, by the web page plug-in, the contents in the first web page from the first link comprises:
crawling, by the web page plug-in, the contents in the first web page from the first link; or
notifying, by the web page plug-in, a client device initiating the first message to crawl the contents in the first web page from the first link, the contents in the first web page crawled by the client device being reported to the web page plug-in.

19. The electronic device of claim 17, the acts further comprising:
determining that the web page plug-in is enabled in the interaction between the user and the digital assistant based on the first message including the first link.

20. A non-transitory computer-readable storage medium storing thereon a computer program executable by a processor to implement acts comprising:
in response to detecting that a digital assistant is triggered for an interaction event based on a first web page, providing a first link of the first web page or contents in the first web page to a web page plug-in, the web page plug-in being configured to perform a web page processing task; and
performing, using the web page plug-in, interaction between a user and the digital assistant based on the contents in the first web page in an interaction window between the user and the digital assistant.
